(19) United States
(12) Patent Application Publication
(10) Pub. No.: US 2023/0394345 A1
(43) Pub. Date: Dec. 7, 2023

(54) QUBIT COUPLING OVER DISTANCE WITH MULTI-MODE BUSES

(71) Applicant: International Business Machines Corporation, Armonk, NY (US)

(72) Inventor: David C. Mckay, Ossining, NY (US)

(21) Appl. No.: 17/816,178

(22) Filed: Jul. 29, 2022

Related U.S. Application Data
(60) Provisional application No. 63/364,378, filed on May 9, 2022.

(51) Int. Cl. G06N 10/40

(52) U.S. Cl. CPC G06N 10/40

(57) ABSTRACT

Technology provided herein relates to coupling of qubits to one another. A system can comprise a first qubit chip and a second qubit chip, a plurality of coupling elements electrically coupling together the first qubit chip and the second qubit chip, and an interposer chip electrically coupling together the plurality of coupling elements. In another embodiment, a system can comprise a first chip comprising a plurality of first qubits, a second chip comprising a plurality of second qubits, and an interposer chip electrically connected between the first chip and the second chip, wherein individual first qubits, of the plurality of first qubits, are electrically coupled to individual second qubits, of the plurality of second qubits, and wherein the electrical coupling of the individual first qubits to the individual second qubits is by series-connected sets of capacitively-coupled elements over the interposer chip.

### TECHNICAL FIELD

The present disclosure relates to quantum computing, and more specifically, to coupling of qubits.

### BACKGROUND

In quantum computing systems, it can be challenging to couple qubits and/or to couple qubits over distance without affecting quality of qubit measurements and/or state of one or more of the coupled or adjacent qubits of a system having a plurality of qubits. These challenges can increase as quantum computing devices expand in size and quantity of qubits.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments described herein, systems, computer-implemented methods, apparatuses and/or computer program products can provide a process to couple qubits and to activate one or more couplings coupling the qubits.

Generally, an electronic device, system and or method for coupling qubits can comprise a first qubit chip and a second qubit chip electrically coupled to one another by a plurality of coupling elements that are electrically coupled to one another by an interposer chip. The coupling elements can be resonators, such as coplanar waveguide resonators, that can be capacitively-coupled to one another. The coupling elements can be series-connected and can comprise at least one fixed frequency coupling element. In one or more embodiments, a superconducting quantum interference device can be disposed at each of at least a pair of tunable coupling elements of the coupling elements.

In accordance with an embodiment, a system can comprise a first qubit chip and a second qubit chip, a plurality of coupling elements electrically coupling together the first qubit chip and the second qubit chip, and an interposer chip electrically coupling together the plurality of coupling elements.

An advantage of the above-indicated system can be facilitation of coupling of qubits (e.g., an addressable two-level system) absent one or more constraints that can result from conventional short coupling distance between respective qubit chips comprising the qubits. That is, one or more of these features can provide connection of qubit chips over distances greater than or equal to about 1 cm, while providing a clean spectrum for the qubit chips.

As used herein, a “two-level system”, also known as a two-state system, is a quantum system that can exist in any quantum superposition of two independent quantum states. In one or more embodiments, a Hilbert space describing a two-level system can be two-dimensional.

As used herein, a “clean spectrum” can refer to a spectrum that has little to no noise, feedback and/or other interference.

In accordance with another embodiment, a method can comprise electrically coupling together a first qubit chip and a second qubit chip by a plurality of coupling elements across an interposer chip.

An advantage of the above-indicated method can be facilitation of coupling of qubits (e.g., an addressable two-level system) absent one or more constraints that can result from conventional short coupling distance between respective qubit chips comprising the qubits.

In accordance with yet another embodiment, a method can comprise executing a quantum operation at a quantum device comprising a pair of qubits electrically connected to one another across an interposer chip by a plurality of coupling elements.

An advantage of the above-indicated system can be use of coupled qubits (e.g., an addressable two-level system) absent one or more constraints that can result from conventional short coupling distance between respective qubit chips comprising the qubits.

A system can comprise a first chip comprising a plurality of first qubits, a second chip comprising a plurality of second qubits, and an interposer chip coupled to the first chip and to the second chip, wherein at least one first qubit, of the plurality of first qubits, is electrically coupled to at least one second qubit, of the plurality of second qubits, and wherein the electrical coupling of the individual first qubits to the individual second qubits is by series-connected sets of capacitively-coupled elements over the interposer chip.

An advantage of the above-indicated system can be facilitation of coupling of qubits (e.g., an addressable two-level system) absent one or more constraints that can result from conventional short coupling distance between respective qubit chips comprising the qubits.

Yet another advantage of the one or more embodiments described herein can be connection of qubit chips over distance while employing galvanic isolation from one qubit chip to another.

As used herein, “galvanic isolation” can refer to lack of direct electrical connection, isolating functional sections of an electrical system to limit and/or prevent current flow. However, energy and/or information can be exchanged by one or more suitable means, such as capacitive means, inductive means, acoustic means and/or the like.

Yet another advantage of the one or more embodiments described herein can be coupling of qubit chips to one another and actuation of the coupling elements without control lines for such actuation being directly connected to an interposer structure coupled between and to the qubit chips.

Yet another advantage of the one or more embodiments described herein can be greater modularity (e.g., greater variance of arrangements, connections, distances between components, and/or the like) of a multi-qubit chip and/or multi-qubit quantum computing device setup. Fewer conventional limits on qubit/qubit chip placement relative to one another can be realized as compared to conventional approaches.

The one or more innovations, frameworks, systems, devices and/or methods described herein can be additionally, and/or alternatively described as follows:

A system can comprise a first qubit chip and a second qubit chip, a plurality of coupling elements electrically coupling together the first qubit chip and the second qubit chip, and an interposer chip electrically coupling together the plurality of coupling elements.

In accordance with the system, the coupling elements can be resonators that are capacitively-coupled to one another.

In accordance with the system of any previous paragraph of this section, the resonators can be coplanar waveguide resonators.

The system of any previous paragraph of this suction further can comprise at least three series-connected coupling elements, wherein, optionally, the middle coupling element can be a fixed frequency coupling element.

The system of any previous paragraph of this suction further can comprise at least three series-connected coupling elements, wherein, optionally, the two outer coupling elements are tunable frequency coupling elements.

The system of any previous paragraph of this suction further can comprise a superconducting quantum interference device disposed at the two outer coupling elements.

The system of any previous paragraph of this suction further can comprise at least three series-connected coupling elements, wherein, optionally, all three coupling elements are fixed frequency coupling elements.

The system of any previous paragraph of this suction further can comprise a superconducting quantum interference device (SQUID) loop located between a structure on the first qubit chip and a structure on the second qubit chip.

In accordance with the system of any previous paragraph of this suction the coupling elements can comprise a first coupling element physically coupled to the first qubit chip and to the interposer chip, a second coupling element physically coupled to the second qubit chip and to the interposer chip, and a third coupling separate from direct coupling to either of the first qubit chip or the second qubit chip.

The system of any previous paragraph of this suction further can comprise a pulse generation component that generates a pulse to affect the first qubit or the second qubit.

A method can comprise electrically coupling together a first qubit chip and a second qubit chip by a plurality of coupling elements across an interposer chip.

The method further can comprise coupling the coupling elements together in series.

The method of any previous paragraph of this section further can comprise coupling a capacitor between sets of two connected coupling elements.

The method of any previous paragraph of this section further can comprise coupling a superconducting quantum interference device at a coupling element of the plurality of coupling elements.

A method can comprise executing a quantum operation at a quantum device comprising a pair of qubits electrically connected to one another across an interposer chip by a plurality of coupling elements.

In accordance with the method, the plurality of coupling elements can comprise series-connected, capacitively-coupled resonators.

The method of any previous paragraph of this section further can comprise executing the quantum operation by operating a cross-resonance gate.

The method of any previous paragraph of this section further can comprise flux tuning a resonator of the plurality of coupling elements.

The method of any previous paragraph of this section further can comprise tuning a qubit of the pair of qubits into a tunable-frequency coupling element of the plurality of coupling elements.

A system can comprise a first chip comprising a plurality of first qubits, a second chip comprising a plurality of second qubits, and an interposer chip coupled to the first chip and to the second chip, wherein at least one first qubit, of the plurality of first qubits, is electrically coupled to at least one second qubit, of the plurality of second qubits, and wherein the electrical coupling of the individual first qubits to the individual second qubits is by series-connected sets of capacitively-coupled elements over the interposer chip.

In accordance with the system, the capacitively-coupled elements of the series-connected sets can comprise at least three resonators, wherein the resonators can be fixed frequency resonators.

In accordance with the system of any previous paragraph of this section, the frequency of the fixed frequency resonators can be above the frequency of the at least one first qubit and the at least one second qubit.

In accordance with the system of any previous paragraph of this section, the capacitively-coupled elements of the series-connected sets comprise at least three resonators, wherein at least one resonator is a fixed frequency resonator, and wherein at least one resonator is a tunable frequency resonator.

In accordance with the system of any previous paragraph of this section, the frequency of the at least three resonators can be above the frequency of the at least one first qubit and the at least one second qubit.

In accordance with the system of any previous paragraph of this section, the capacitively-coupled elements of the series-connected sets can comprise at least three resonators, and optionally, at least one resonator of the at least three resonators can be located on the first chip and on the interposer chip.

### DESCRIPTION OF THE DRAWINGS

FIG. 1 illustrates a schematic view of a system, in accordance with one or more embodiments described herein.

FIG. 2 illustrates a schematic view of a device embodiment and a block diagram of the embodiment, which embodiment can be employed in the system of FIG. 1, in accordance with one or more embodiments described herein.

FIG. 3 illustrates a pair of graphs demonstrating simulation of qubit frequencies and anharmonicities relative to the device of FIG. 2 having only three fixed-frequency coupler elements, in accordance with one or more embodiments described herein.

FIG. 4 illustrates a block diagram of a system comprising a plurality of devices of FIG. 2, in accordance with one or more embodiments described herein.

FIG. 5 illustrates a schematic view of another device embodiment, which embodiment can be employed in the system of FIG. 1, in accordance with one or more embodiments described herein.

FIG. 6A illustrates a graph demonstrating simulation of qubit frequencies and/or anharmonicities relative to the device of FIG. 5 having only three fixed-frequency coupler elements, in accordance with one or more embodiments described herein. FIG. 6B illustrates two graphs also demonstrating simulation of qubit frequencies and/or anharmonicities relative to the device of FIG. 5 having only three fixed-frequency coupler elements, in accordance with one or more embodiments described herein.

FIG. 7 depicts a schematic view of yet another device embodiment, which embodiment can be employed in the system of FIG. 1, in accordance with one or more embodiments described herein.

FIG. 8 illustrates a pair of graphs demonstrating simulation of qubit frequencies and anharmonicities relative to the device of FIG. 7 having only three fixed-frequency coupler elements, in accordance with one or more embodiments described herein.

FIG. 9 illustrates a process flow for a method of manufacture of a system in accordance with one or more embodiments described herein.

FIG. 10 illustrates a process flow for a method of use of a system in accordance with one or more embodiments described herein.

FIG. 11 illustrates a block diagram of an example, non-limiting, operating environment in which one or more embodiments described herein can be provided.

FIG. 12 illustrates a block diagram of an example, non-limiting, cloud computing environment in accordance with one or more embodiments described herein.

FIG. 13 illustrates a block diagram of example, non-limiting, abstraction model layers in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

As used herein, a quantum circuit can be a set of operations, such as gates, performed on a set of real-world physical qubits with the purpose of obtaining one or more qubit measurements. A quantum processor can comprise the one or more real-world physical qubits.

To enable useful quantum operation of devices, qubits are coupled, but there can be limitations to this coupling. In a typical arrangement, qubits can be coupled by circuit elements (capacitors, inductors, resonators) that are on a same chip (e.g., qubit chip). This can limit and/or prevent issues that can arise, such as crosstalk, by good electrical connection between elements. There also can be limits on the strength of coupling such as to achieve expected non-coupled states.

In addition, one or more such limits can respectively limit modularity of, arrangement of, and/or distances of between qubits and/or qubit-chips comprising the qubits. This limited arrangement itself can limit the types of operations (e.g., quantum gates) that can be executed. Further the hardware employed to couple qubits generally can, in one or more cases, introduce some error, such as some level of decoherence and/or some level of quantum noise, affecting qubit availability and/or coherence. Quantum noise can refer to noise attributable to the discrete and/or probabilistic natures of quantum interactions.

Generally, in a quantum device, a pair of superconducting Josephson junction qubits (e.g., transmon qubits) can be capacitively coupled to a length of co-planar waveguide. The length of a co-planar waveguide is such that it can provide a resonance where the wavelength can be twice the length of the waveguide (L/2 resonator). As used herein, a co-planar waveguide refers to a type of electrical planar transmission line having conductors at a same side of a substrate, and hence being coplanar. In a dielectric of permittivity e, the length of a resonator of frequency fr can be

$$\frac{c}{2 {f}_{r} {ϵ}^{0.5}} ,$$

where c is the speed of light in vacuum and ε is the permittivity of the substrate. For example, 6 GHz on a silicon substrate, where e is half air and half silicon, can be about 10 millimeters (mm).

In one or more embodiments, information can be moved to a secondary interposer chip between qubit chips. This can be accomplished with couplers that are disposed close to the edge of the qubit chips, using a short coupling section on the interposer.

If the bus is too long, such as longer than about 10 mm, the bus can resonate in a frequency close to one of the qubits that the bus is connecting. For a long resonator, e.g., bus, there can be modes at

$${f}_{n} = \frac{c n}{2 L {ϵ}^{0.5}}$$

having nigner frequency that can be ignored in that the higher frequency modes are far above the qubit frequency. However, for a long resonator this is not the case. For example, at 10 cm a resonator on half air/half silicon can have a frequency of about 300 megahertz (MHz) and there can be 20 modes from there until the qubit frequency. In view thereof, qubits cannot be cleanly coupled by such resonator.

In one or more embodiments, a plurality of resonators can be coupled together at the same frequency to form a bandpass structure at a single qubit chip. The mean resonance can be that of an individual bus.

It also can be desirable to provide a qubit coupling separated by length scales greater than or equal to 1 centimeter (cm) across qubit chips, e.g., connecting plural qubit chips. It can be desirable to provide such structure where an interposer structure lacks control lines on the interposer structure, where a clean spectrum comprises modes greater than about 200 MHz away from the qubits to avoid frequency collisions, and where there is galvanic isolation from one qubit chip to another.

As used herein, a “clean spectrum” can refer to a spectrum that has little to no noise, feedback and/or other interference.

As used herein, “galvanic isolation” can refer to lack of direct electrical connection, isolating functional sections of an electrical system to limit and/or prevent current flow. However, energy and/or information can be exchanged by one or more suitable means, such as capacitive means, inductive means, acoustic means and/or the like.

One or more embodiments are now described with reference to the drawings, where like referenced numerals are used to refer to like elements throughout.

As used herein, the terms “entity”, “requesting entity”, and “user entity” can refer to a machine, device, component, hardware, software, smart device and/or human.

As used herein, “coupler”, “coupler element”, and “coupling element” can be interchangeable.

In the following description, for purposes of explanation, numerous specific details are set forth in order to provide a more thorough understanding of the one or more embodiments. It is evident, however, in various cases, that the one or more embodiments can be practiced without these specific details.

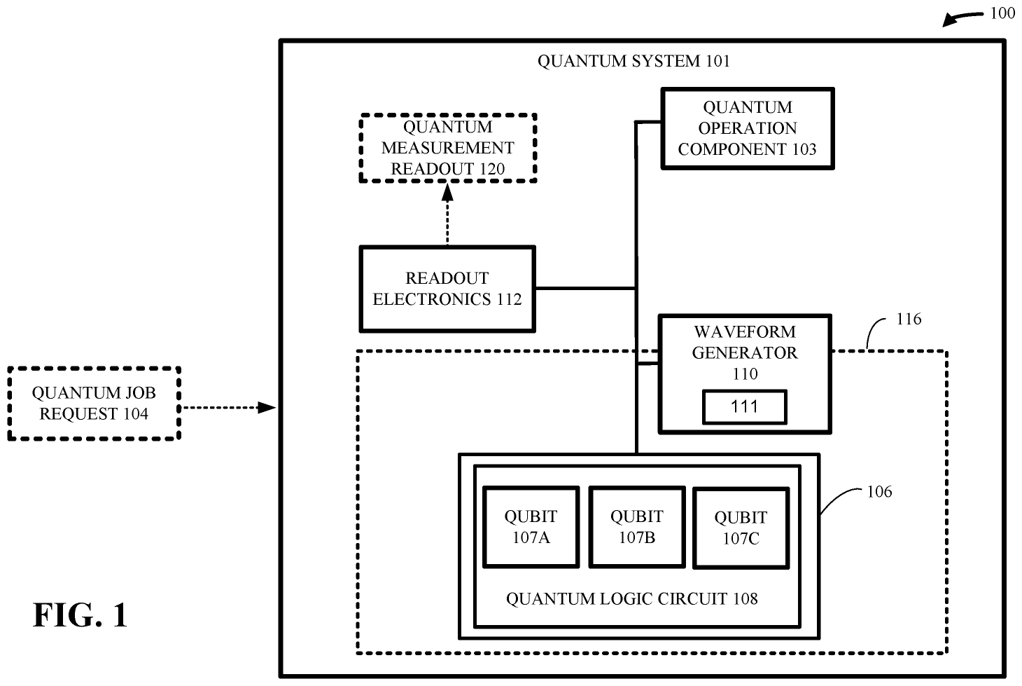

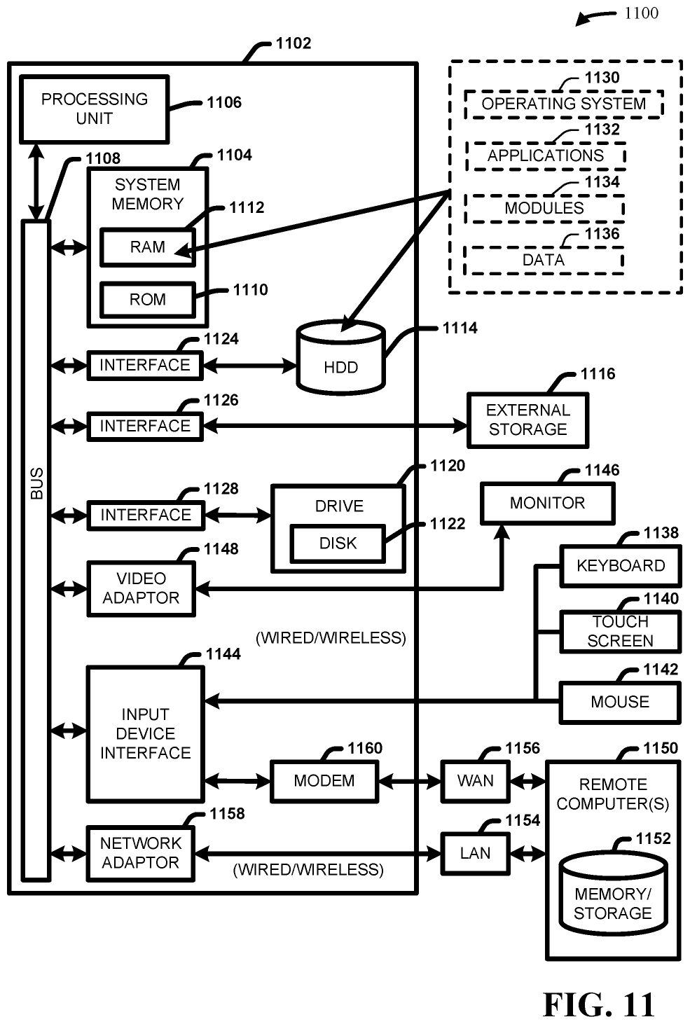

Further, the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 of FIG. 1, can further comprise, be associated with, and/or be coupled to one or more computer and/or computing-based elements described herein with reference to an operating environment, such as the operating environment 1100 illustrated at FIG. 11. In one or more described embodiments, computer and/or computing-based elements can be used in connection with implementing one or more of the systems, devices, components and/or computer-implemented operations shown and/or described in connection with FIG. 1 and/or with other figures described herein.

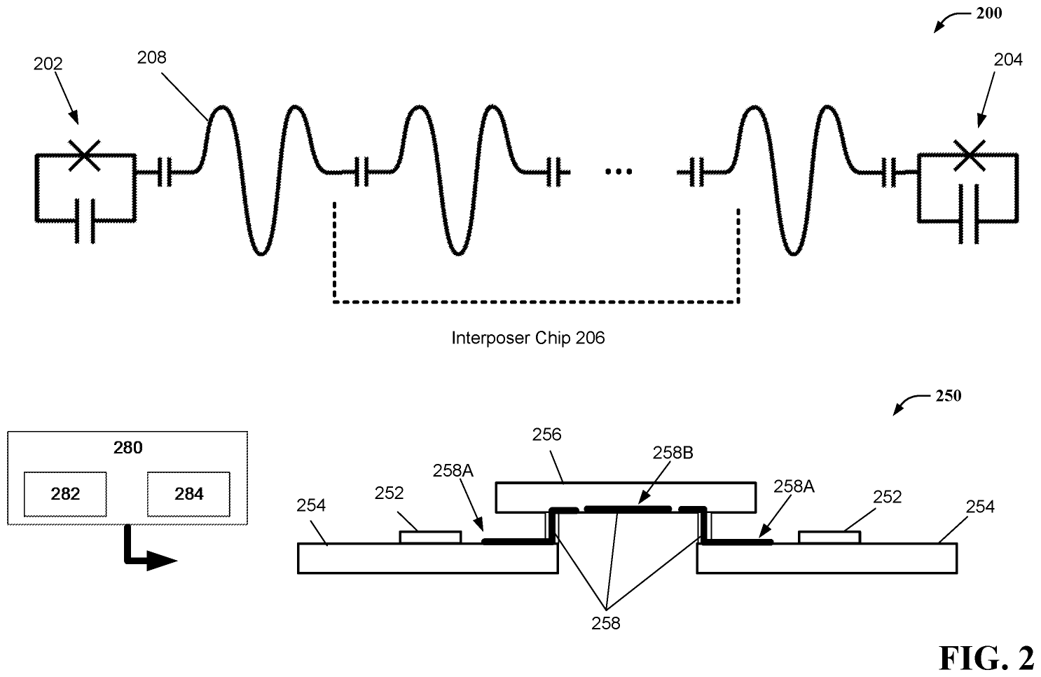

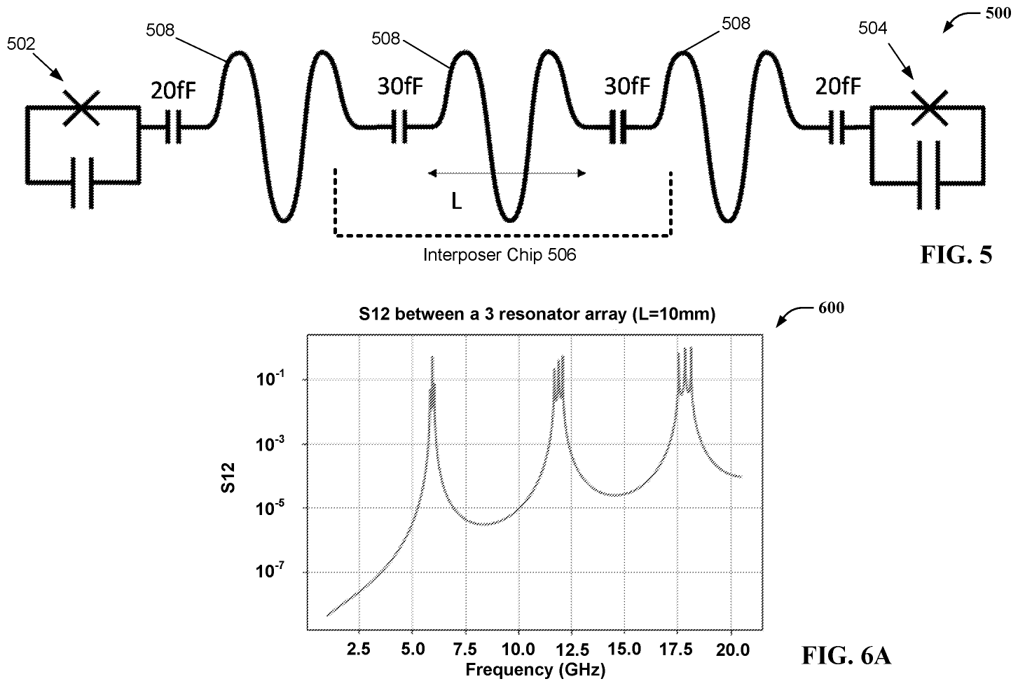

Turning first generally to FIG. 1, one or more embodiments described herein can include one or more devices, systems and/or apparatuses that can provide a process to execute one or more quantum operations, such as perform one or more quantum gates. At FIG. 1, illustrated is a block diagram of an example, non-limiting system 100 that can provide such probing process, in accordance with one or more embodiments described herein. While referring here to one or more processes, facilitations and/or uses of the non-limiting system 100, description provided herein, both above and below, also can be relevant to one or more other non-limiting systems described herein, such as the devices/systems of FIGS. 2, 5 and/or 7, to be described below in detail.

The following/aforementioned description(s) refer(s) to the operation of a single quantum program from a single quantum job request. This operation can include one or more readouts from cryogenic environment electronics within cryogenic chamber 116 by room temperature control/readout electronics 112 external to the cryogenic chamber 116. That is, one or more of the processes described herein can be scalable, also such as including additionally, and/or alternatively, execution of one or more quantum programs and/or quantum job requests in parallel with one another. Scalability of efficient readout can be enabled by employing semiconductor devices 111 in quantity.

In one or more embodiments, the non-limiting system 100 can be a hybrid system and thus can include both one or more classical systems, such as a quantum program implementation system, and one or more quantum systems, such as the quantum system 101. In one or more other embodiments, the quantum system 101 can be separate from, but function in combination with, a classical system.

In such case, one or more communications between one or more components of the non-limiting system 100 and a classical system can be facilitated by wired and/or wireless means including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced network technology (ANT), an ultra-wideband (UWB) standard protocol and/or other proprietary and/or non-proprietary communication protocols.

In one or more other embodiments, the classical system can provide a quantum job request 104, qubit mapping, quantum circuit to be executed and/or the like. Such classical system can analyze the one or more quantum measurement readouts 120. Further, such classical system can manage a queueing of quantum circuits to be operated on the one or more qubits of the quantum logic circuit of a respective quantum system 101.

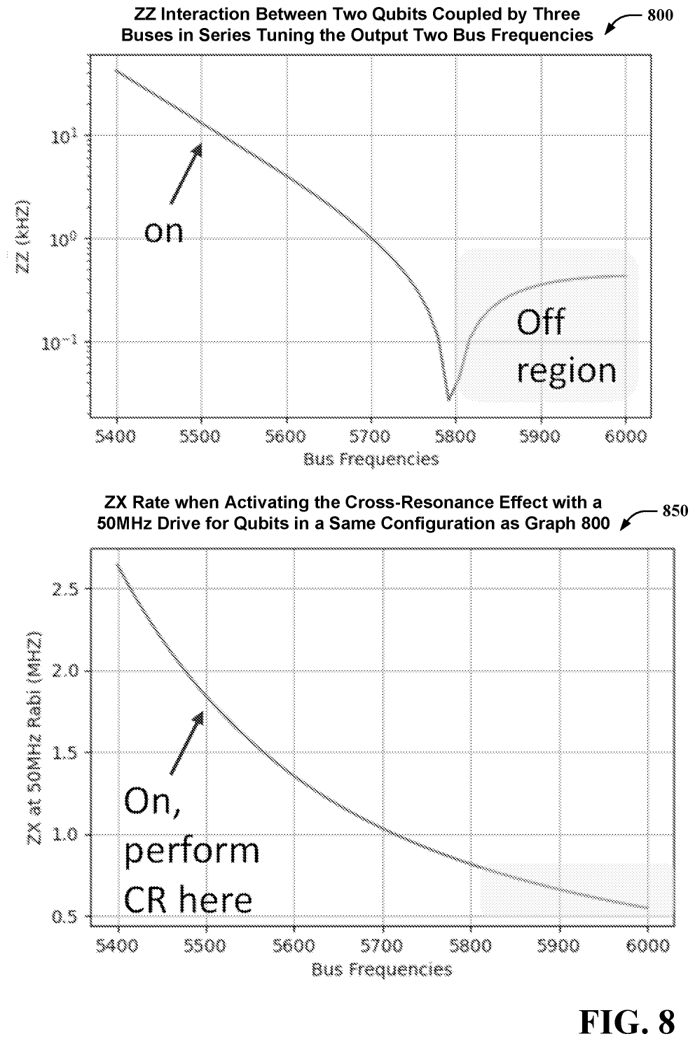

For example, in one or more embodiments, the non-limiting systems described herein, such as non-limiting system 100 as illustrated at FIGS. 1, and/or systems thereof, can further comprise, be associated with and/or be coupled to one or more computer and/or computing-based elements described herein with reference to an operating environment, such as the operating environment 800 illustrated at FIG. 8. In one or more described embodiments, computer and/or computing-based elements can be used in connection with implementing one or more of the systems, devices, components and/or computer-implemented operations shown and/or described in connection with FIG. 1 and/or with other figures described herein.

The quantum system 101 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuity can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement 120, can be responsive to the quantum job request 104 and associated input data and can be based at least in part on the input data, quantum functions and/or quantum computations.

In one or more embodiments, the quantum system 101 can comprise one or more quantum components, such as a quantum operation component 103, a quantum processor 106, quantum readout/control electronics 112, a waveform generator 110, and/or a quantum logic circuit 108 comprising one or more qubits (e.g., qubits 107A, 107B and/or 107C), also referred to herein as qubit devices 107A, 107B and 107C.

The quantum processor 106 can be any suitable processor. The quantum processor 106 can generate one or more instructions for controlling the one or more processes of the quantum logic circuit 108 and/or waveform generator 110.

The quantum operation component 103 can obtain (e.g., download, receive, search for and/or the like) a quantum job request 104 requesting execution of one or more quantum programs. The quantum operation component 103 can determine one or more quantum logic circuits, such as the quantum logic circuit 108, for executing the quantum program. The request 104 can be provided in any suitable format, such as a text format, binary format and/or another suitable format. In one or more embodiments, the request 104 can be received by a component other than a component of the quantum system 101, such as a by a component of a classical system coupled to and/or in communication with the quantum system 101.

The waveform generator 110 can perform one or more waveform operations for operating and/or affecting one or more quantum circuits on the one or more qubits 107A, 107B and/or 107C. For example, the waveform generator 110 can operate one or more qubit effectors, such as qubit oscillators, harmonic oscillators, pulse generators and/or the like to cause one or more pulses to stimulate and/or manipulate the state(s) of the one or more qubits 107A, 107B and/or 107C comprised by the quantum system 101.

The waveform generator 110 can comprise one or more semiconductor devices 111 having a respective closely co-integrated resonant tunneling diode (RTD) and field effect transistor (FET). This co-integration can provide for flow along a respective substrate or base surface (e.g., where the substrate is removed from, if the substrate is removed) between the RTD and FET.

Employing the semiconductor device 111, such as a semiconductor chip, the waveform generator 110 can generate a qubit control pulse employing low power, such as less than 1 milliwatt per qubit (mW/qubit). In quantity, the power employed by such semiconductor devices can more readily be cooled by a cooling system (e.g., dissipated), such as inside a respective cryogenic chamber.

The waveform generator 110, such as in combination with the quantum processor 106, can execute operation of a quantum logic circuit on one or more qubits of the circuit (e.g., qubit 107A, 107B and/or 107C). In response, the quantum operation component 103 can output one or more quantum job results, such as one or more quantum measurements 120, in response to the quantum job request 104.

The quantum logic circuit 108 and a portion or all of the waveform generator 110 and/or quantum processor 106 can be contained in a cryogenic environment, such as generated by a cryogenic chamber 116, such as a dilution refrigerator. The semiconductor device 111 can thus be employed in a cryogenic environment. Indeed, a signal can be generated by the waveform generator 110 to affect the one or more qubits 107A-C. Where qubits 107A, 107B and 107C are superconducting qubits, cryogenic temperatures, such as about 4 Kelvin (K) or lower can be employed to facilitate function of these physical qubits. Accordingly, the elements of the waveform generator 110, including the semiconductor device 111, also are to be constructed to perform at such cryogenic temperatures.

Turning now to additional FIGS. 2-10, varying embodiments of devices/systems than can be employed, where applicable as at least a portion of the quantum processor 106 or the quantum logic circuit 108 are described herein. Although, descriptions of the aspects of FIGS. 2-10 can stand on their own, separate from any connection, implied, direct or otherwise, to the aspects of FIG. 1.

FIG. 2 illustrates a schematic view of a device 200 having a first qubit 202, a second qubit 204 and a plurality of couplers 208. The first and second qubit 202/204 are coupled to one another by the plurality of couplers 208, also herein referred to as coupling elements or coupler elements. The plurality of couplers 208 comprises at least three couplers 208 coupled in series. The outermost (e.g., end) couplers are disposed partially on a respective qubit chip 202/204 and partially on an interposer chip 206. The central coupler 208 is disposed on the interposer chip 206.

Turning to a next iteration 250 of the device 200, a coupling structure is provided that can span across (e.g., between and connecting) a pair of qubits of a pair of qubit chips (e.g., spanning across the pair of qubit chips) 254.

Qubits on the qubit chips 254 can be transmons or any other type of superconducting qubit that can be capable of being bus coupled. The side view of the device iteration 250 illustrates the qubits at 252, qubit chips at 254, interposer at 256 and three coupler elements at 258. It is noted that 252 can illustrate qubit location and not a physical structure. The coupler elements 258 can be fixed frequency elements. The coupler elements 258 can be resonators, such as co-planar waveguide (CPW) resonators. In one or more embodiments, at least three coupler elements 258 can be provided in series, with only the end-most coupler elements 258 A contacting each of the interposer 256 and a qubit chip 254. The middle coupler element 258 B is not in contact with the qubit chips 254 and is disposed only at the interposer (e.g., interposer chip) 256.

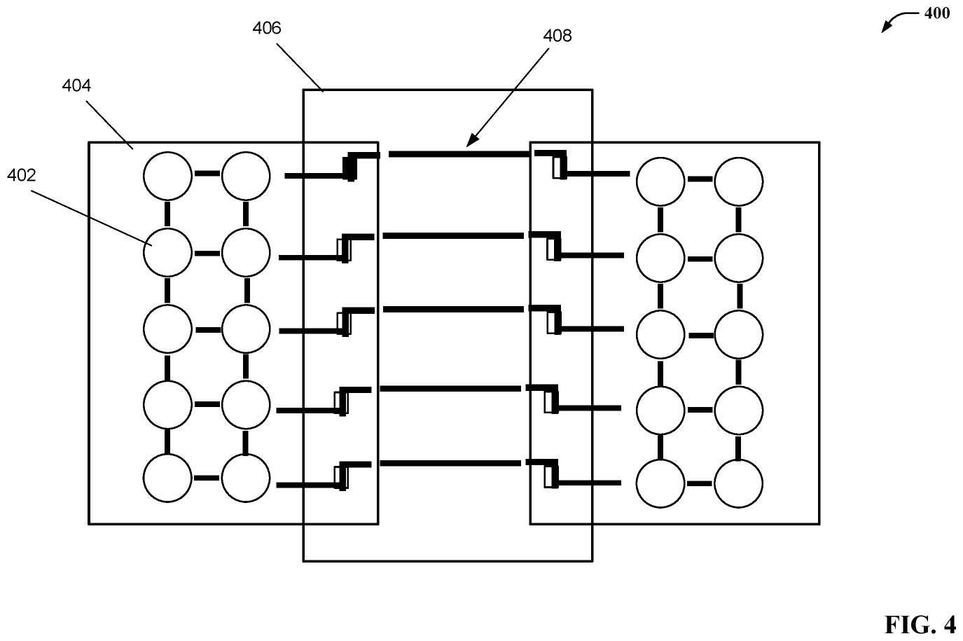

Next, FIG. 4 illustrates a top view of another device 400 comprising multiple of the devices 250. FIG. 4 illustrates that the qubit chips 404 each can comprise a plurality of qubits 402 coupled to one another, with qubits 402 of different qubit chips 404 being coupled by the interposer 406 and coupler elements 408. In one or more embodiments, the coupler elements illustrated at FIG. 4 are fixed-frequency coupler elements that can operate with a cross-resonance gate.

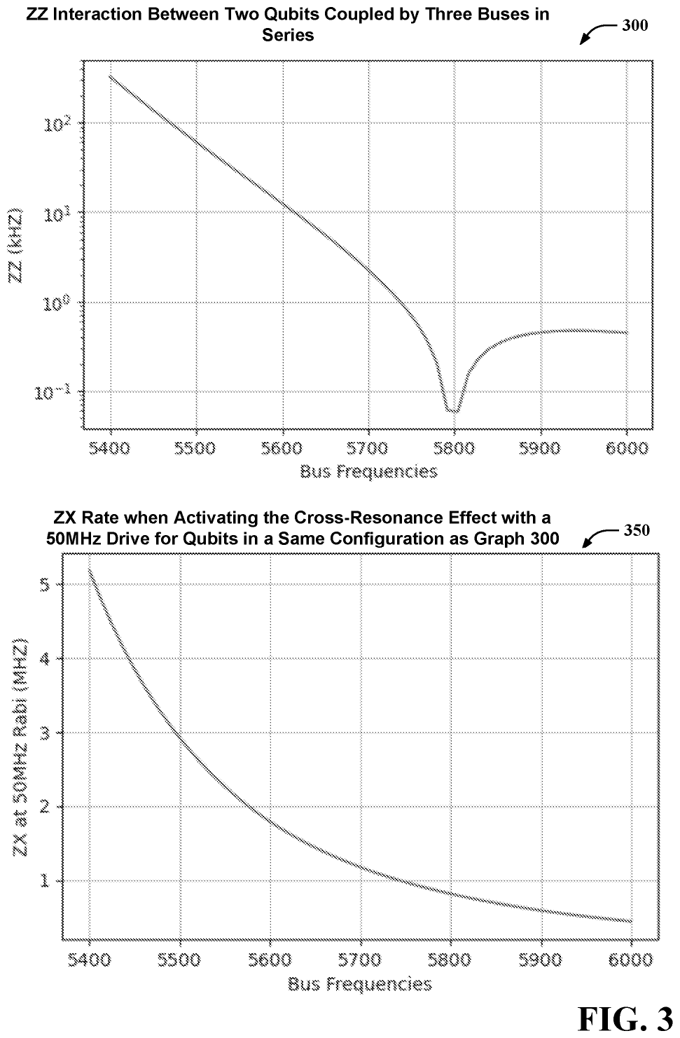

Turning now to FIG. 3, illustrated are a pair of graphs demonstrating simulation of qubit frequencies of 5 gigahertz (GHz) and 5.05 GHz, anharmonicities of −300 megahertz (MHz) and g=130 MHz, relative to the device 600 having only three fixed-frequency coupler elements. It is noted that based on the results shown at the graphs, bus frequencies of 5.6 GHz can provide good performance, for example, as there is low ZZ and enough ZX rate when utilizing the cross-resonance effect with an experimentally typical drive power of 50 MHz.

For the simulation resulting in the graphs of FIG. 3, a Hamiltonian simulation was employed with a single mode per bus. An equation representing an example Hamiltonian for the simulation is provided below at Equation 1.

$$H = {\sum }_{i = 0 , 1} {ω}_{i} {n}_{i} + {g}_{0 , 0} ( {a}_{0} + {a}_{0}^{†} ) ( {b}_{0} + {b}_{0}^{†} ) + {g}_{1 , N - 1} ( {a}_{1} + {a}_{1}^{†} ) ( {b}_{N - 1} + {b}_{N - 1}^{†} ) + {\sum }_{j = 0 , N - 1} {ω}_{B U S , j} {b}_{j}^{†} {b}_{j} + {g}_{j , j + 1} ( {b}_{j} + {b}_{j}^{†} ) ( {b}_{j + 1} + {b}_{j + 1}^{†} ) \qquad Equation 1$$

At Equation 1, ωᵢ is the qubit frequency, i=0,1, ω_{BUS,j} is the bus j frequency, g_{0,0} is coupling strength between qubit 0 and bus 0, g_{1,N-1} is coupling strength between qubit 1 and bus N−1, g_{j,j} is coupling strength between bus j and bus j+1, aᵢ is the annihilation operator for qubit and bᵢ is the annihilation operator for bus i.

Referring next to FIG. 5, provided below, illustrated is a device 500 having a pair of qubit chips coupled by a set of exactly three couplers. Capacitors can be employed between each of the qubits 502, 504 and the couplers 508, and between each of the couplers 508. The couplers 508 can be transmission line busses having multi-modes. The middle coupler 508 can be disposed only on the interposer chip 506. L represents the length of the central bus 508.

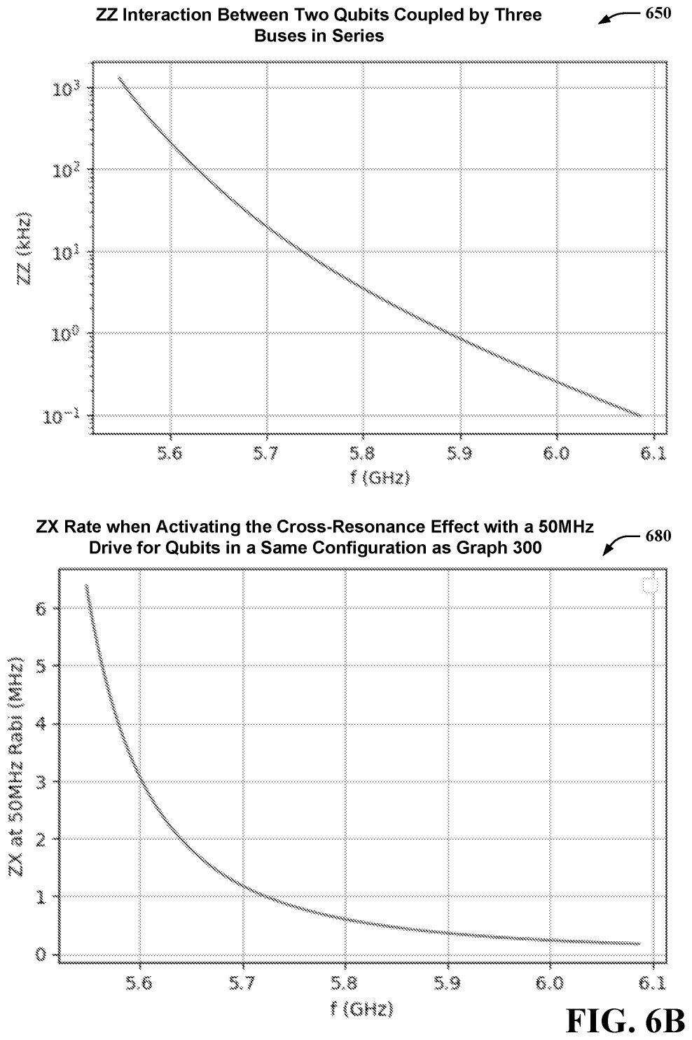

At FIG. 6, illustrated are a set of three graphs demonstrating simulation of qubit frequencies of 5 GHz and 5.05 GHz and anharmonicities of −325 MHz relative to the device 500 having only three fixed-frequency coupler elements. In this simulation, a full circuit model was considered and so the effect of multiple resonances per co-planar waveguide is part of the simulation. Varying lengths L of the center coupler element 608 were swept from 10.3 millimeters (mm) to greater than 11.33 mm (e.g., convert to frequencies with native

$$\frac{c}{2 ( L ) ( {ℰ}^{0.5} )} ) .$$

At graph 600, for example, which is a classical simulation of the three-resonator network, measuring S12, illustrates that there are multiple higher frequency resonances in this bus structure. Graphs 650 and 680 are analogous to graphs 300 and 350 and illustrate that the higher order modes of the resonators do not appreciably change the results of the simulation. Bus frequencies between 5.6 GHz and 5.7 GHz can provide good performance.

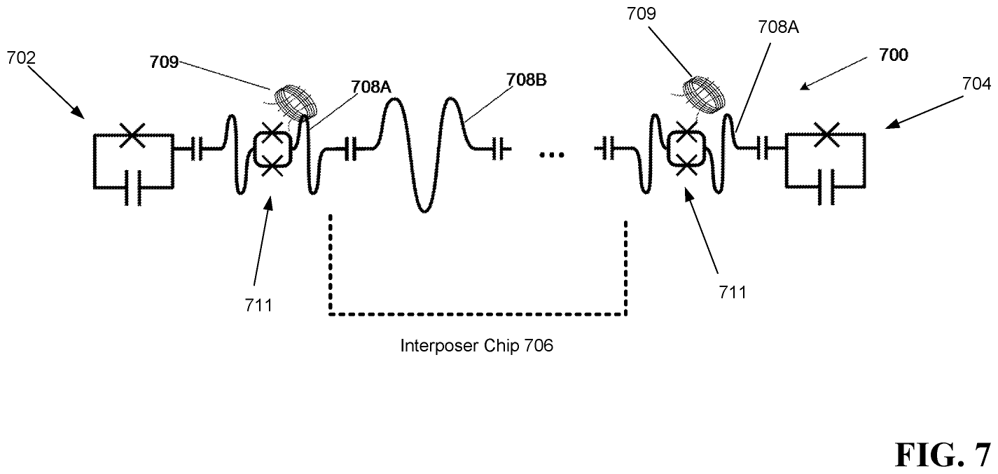

Referring next to FIG. 7, illustrated is a device structure 700 comprising a pair of qubits 702 and 704 coupled by at least three coupler elements. A center coupler element 708B is fixed frequency. The center coupler element 708B can be separate from direct coupling to either of the first qubit chip (or first qubit 702) or the second qubit chip (or second qubit 704). The outermost coupler elements 708A, e.g., those contacting both a respective qubit chip and an interposer chip 706 therebetween, can be tunable. Frequency tuning control lines 709 can be disposed at the qubit chips, and thus can be separate from direct connection to the interposer chip 706 there between. The device 700 can have two modes of operation: coupling on where a cross-resonance gate can be performed, and coupling off.

As illustrated, a superconducting quantum interference device 711 can be disposed at each of the two outer coupling elements 708 A. The superconducting quantum interference device (SQUID) 711 can be a SQUID loop which is thus located between, such as inline and between, a structure on the first qubit chip 702 and a structure on the second qubit chip 704.

Turning now to FIG. 8, illustrated are a pair of graphs demonstrating simulation of qubit frequencies of 5 GHz and 5.05 GHz, anharmonicities of negative 300 MHz and g=130 MHz relative to the device 700 having only three fixed-frequency coupler elements. The center element is fixed-frequency at 5.8 GHz, while the two outer elements in the series are tunable. The graphs 800 and 850 plot similar to the graphs 300 and 350, except it is considered that the outer resonators can be tuned dynamically and so are not limited to having a system at a single value of the x axis. These graphs show that the outer resonators can be at greater than 5.8 GHz when the desire is not to perform a gate, and the outer resonators can be tuned to 5.5 GHz (or about) when it is desired to perform the cross-resonance interaction.

Turning next again to FIG. 2, in one or more embodiments, an entity 280 can perform one or more operations to manufacture an electronic device and/or system that is in accordance with one or more embodiments described herein. For example, an entity 280, such as a manufacturing system, can comprise a controller and/or processor 282. The processor 282 can issue one or more instructions to cause manufacture of the electronic device and/or system. For example, the entity 280 further can comprise one or more nodes 284, such as manufacturing devices, that can be controlled by the controller 282 to manufacture the electronic device and/or system. In an example, a node 284 can be controlled to couple a coupler element to a qubit chip, and/or the like.

In one or more embodiments, the entity 280, and/or another manufacturing entity, can perform one or more operations (e.g., manufacturing operations) corresponding to one or more electronic devices and/or systems described herein.

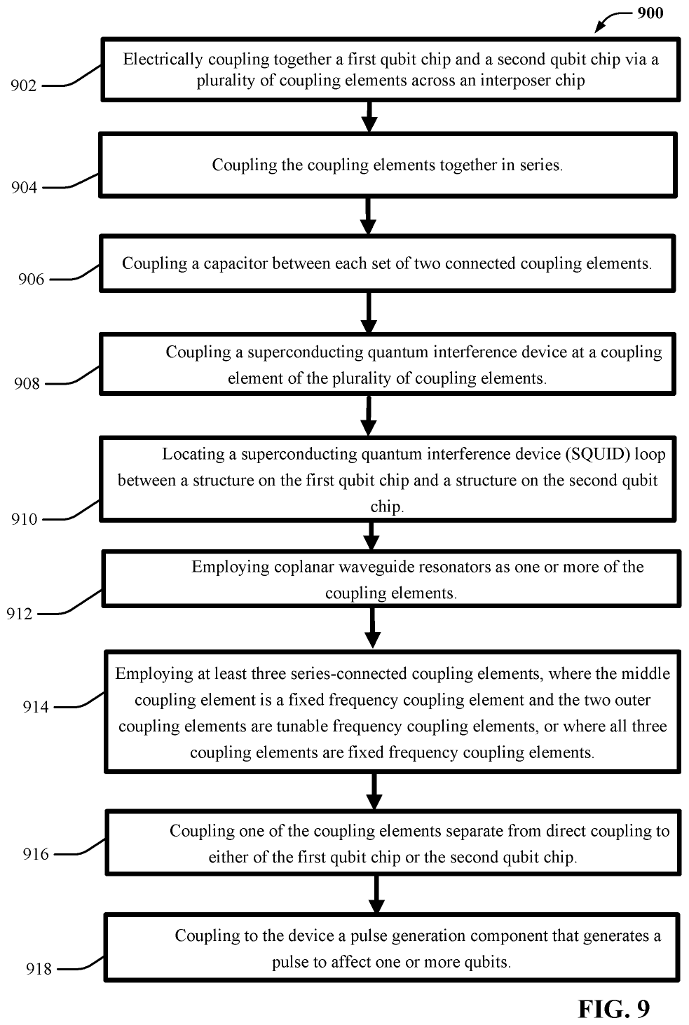

Next, FIG. 9 illustrates a flow diagram of an example, non-limiting method 900 that can provide a process to at least partially construct a device in accordance with one or more embodiments described herein, such as the non-limiting devices of FIGS. 1, 2, 5 and/or 7. Repetitive description of like elements and/or processes employed in respective embodiments is omitted for sake of brevity.

At 902, the non-limiting method 900 can comprise electrically coupling together (e.g., by entity 280) a first qubit chip and a second qubit chip by a plurality of coupling elements across an interposer chip.

At 904, the non-limiting method 900 can comprise coupling (e.g., by entity 280) the coupling elements together in series.

At 906, the non-limiting method 900 can comprise coupling (e.g., by entity 280) a capacitor between sets of two connected coupling elements.

At 908, the non-limiting method 900 can comprise coupling (e.g., by entity 280) a superconducting quantum interference device at a coupling element of the plurality of coupling elements.

At 910, the non-limiting method 900 can comprise locating (e.g., by entity 280) a superconducting quantum interference device (SQUID) loop between a structure on the first qubit chip and a structure on the second qubit chip.

At 912, the non-limiting method 900 can comprise employing (e.g., by entity 280) coplanar waveguide resonators as one or more of the coupling elements.

At 914, the non-limiting method 900 can comprise employing (e.g., by entity 280) at least three series-connected coupling elements, where the middle coupling element is a fixed frequency coupling element and the two outer coupling elements are tunable frequency coupling elements, or where all three coupling elements are fixed frequency coupling elements.

At 916, the non-limiting method 900 can comprise coupling (e.g., by entity 280) one of the coupling elements separate from direct coupling to either of the first qubit chip or the second qubit chip.

At 918, the non-limiting method 900 can comprise further coupling to the device (e.g., by entity 280) a pulse generation component that generates a pulse to affect one or more qubits.

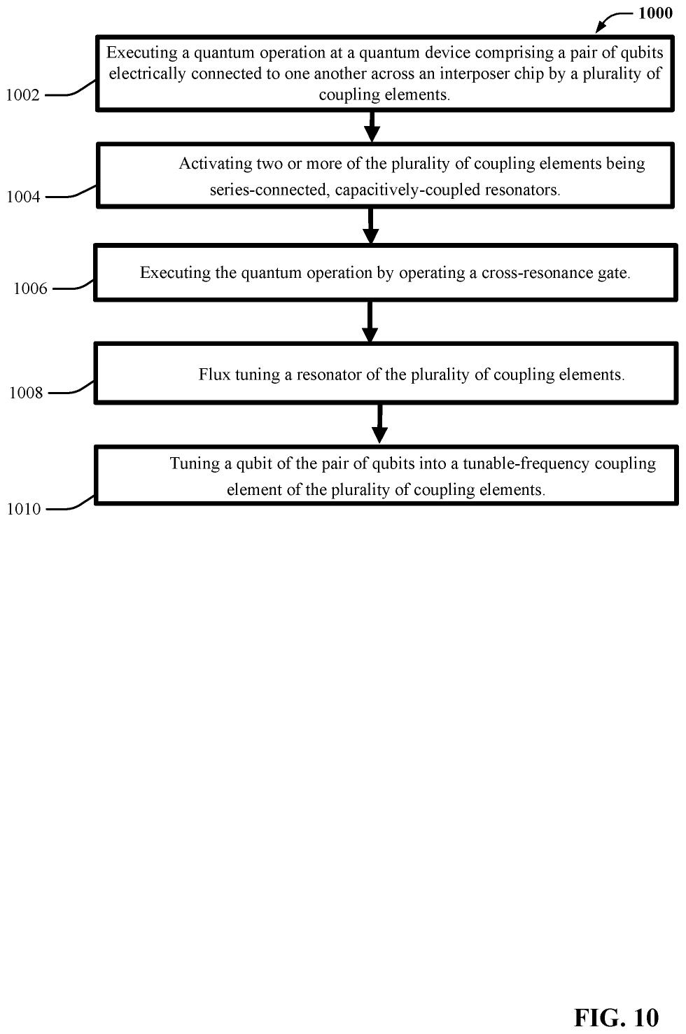

Next, FIG. 10 illustrates a flow diagram of an example, non-limiting method 1000 that can provide a process to at least partially use a device in accordance with one or more embodiments described herein, such as the non-limiting devices of FIGS. 1, 2, 5 and/or 7. Repetitive description of like elements and/or processes employed in respective embodiments is omitted for sake of brevity.

At 1002, the non-limiting method 1000 can comprise executing (e.g., by quantum operation component 103) a quantum operation at a quantum device comprising a pair of qubits electrically connected to one another across an interposer chip by a plurality of coupling elements.

At 1004, the non-limiting method 1000 can comprise activating (e.g., by quantum operation component 103) two or more of the plurality of coupling elements being series-connected, capacitively-coupled resonators.

At 1006, the non-limiting method 1000 can comprise executing (e.g., by quantum operation component 103) the quantum operation by operating a cross-resonance gate.

At 1008, the non-limiting method 1000 can comprise flux tuning (e.g., by quantum operation component 103) a resonator of the plurality of coupling elements.

At 1010, the non-limiting method 1000 can comprise tuning (e.g., by quantum operation component 103) a qubit of the pair of qubits into a tunable-frequency coupling element of the plurality of coupling elements.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states by a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, technology provided herein relates to coupling of qubits to one another. A system can comprise a first qubit chip and a second qubit chip, a plurality of coupling elements electrically coupling together the first qubit chip and the second qubit chip, and an interposer chip electrically coupling together the plurality of coupling elements. In another embodiment, a system can comprise a first chip comprising a plurality of first qubits, a second chip comprising a plurality of second qubits, and an interposer chip electrically connected between the first chip and the second chip, wherein individual first qubits, of the plurality of first qubits, are electrically coupled to individual second qubits, of the plurality of second qubits, and wherein the electrical coupling of the individual first qubits to the individual second qubits is by series-connected sets of capacitively-coupled elements over the interposer chip.

An advantage of one or more of the above-indicated systems and/or methods can be facilitation of coupling of qubits (e.g., an addressable two-level system) absent one or more constraints that can result from conventional short coupling distance between respective qubit chips comprising the qubits. That is, one or more of these features can provide connection of qubit chips over distances greater than or equal to about 1 cm, while providing a clean spectrum for the qubit chips.

Yet another advantage of the one or more embodiments described herein can be connection of qubit chips over greater distances than or equal to about 1 cm while avoiding galvanic connectivity from one qubit chip to another.

In one or more embodiments, one or more of such results can be realized without employing control lines to the interposer structure.

Yet another advantage of the one or more embodiments described herein can be greater modularity (e.g., greater variance of arrangements, connections, distances between components, and/or the like) of a multi-qubit chip and/or multi-qubit quantum computing device setup. Fewer conventional limits on qubit/qubit chip placement relative to one another can be realized as compared to conventional approaches.

Indeed, in view of the one or more embodiments described herein, a practical application of the systems, computer-implemented methods and/or computer program products described herein can be modularity of placement of qubits relative to one another at a multi-qubit quantum device, which modularity can include coupling distances between qubits of greater than or equal to 1 cm. Such is a useful and practical application of computers, thus providing enhanced (e.g., improved and/or optimized) operation of the employed qubits, such as within a quantum logic circuit having plural qubits, such as about 27 qubits, or 1000 qubits, or more. Overall, such computerized tools can constitute a concrete and tangible technical improvement in the field of quantum computing.

Furthermore, one or more embodiments described herein can be employed in a real-world system based on the disclosed teachings. For example, one or more embodiments described herein can function within a quantum system that can receive as input a pulse to affect one or more qubits of the devices and/or systems described herein.

Moreover, a device and/or method described herein can be implemented in one or more domains, such as quantum domains, to enable scaled quantum program executions. Indeed, use of a device as described herein can be scalable, such as where the elements of the embodiments described herein can be usable over varying distances and/or with coupling of varying numbers of qubit pairs and/or qubit sets. These one or more processes can be performed at least partially at a same time as one another.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. Systems, computer-implemented methods and/or computer program products described herein are of great utility in the field of quantum computing and superconducting quantum systems and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively couple qubits as the one or more embodiments described herein. Moreover, neither can the human mind nor a human with pen and paper conduct one or more of these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

Turning next to FIGS. 11-13, a detailed description is provided of additional context for the one or more embodiments described herein at FIGS. 1-10.

FIG. 11 and the following discussion are intended to provide a brief, general description of a suitable operating environment 1100 in which one or more embodiments described herein at FIGS. 1-10 can be implemented. For example, one or more components and/or other aspects of embodiments described herein can be implemented in or be associated with, such as accessible by, the operating environment 1100. Further, while one or more embodiments have been described above in the general context of computer-executable instructions that can run on one or more computers, those skilled in the art will recognize that one or more embodiments also can be implemented in combination with other program modules and/or as a combination of hardware and software.

Generally, program modules include routines, programs, components, data structures and/or the like, that perform particular tasks and/or implement particular abstract data types. Moreover, the aforedescribed methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and/or the like, each of which can be operatively coupled to one or more associated devices.

Computing devices typically include a variety of media, which can include computer-readable storage media, machine-readable storage media and/or communications media, which two terms are used herein differently from one another as follows. Computer-readable storage media or machine-readable storage media can be any available storage media that can be accessed by the computer and includes both volatile and nonvolatile media, removable and non-removable media. By way of example, but not limitation, computer-readable storage media and/or machine-readable storage media can be implemented in connection with any method or technology for storage of information such as computer-readable and/or machine-readable instructions, program modules, structured data and/or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) and/or other optical disk storage, magnetic cassettes, magnetic tape, magnetic disk storage and/or other magnetic storage devices, solid state drives or other solid state storage devices and/or other tangible and/or non-transitory media which can be used to store specified information. In this regard, the terms “tangible” or “non-transitory” herein as applied to storage, memory and/or computer-readable media, are to be understood to exclude only propagating transitory signals per se as modifiers and do not relinquish rights to all standard storage, memory and/or computer-readable media that are not only propagating transitory signals per se.

Computer-readable storage media can be accessed by one or more local or remote computing devices, e.g., via access requests, queries and/or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set and/or changed in such a manner as to encode information in one or more signals. By way of example, but not limitation, communication media can include wired media, such as a wired network, direct-wired connection and/or wireless media such as acoustic, RF, infrared and/or other wireless media.

With reference still to FIG. 11, the example operating environment 1100 for implementing one or more embodiments of the aspects described herein can include a computer 1102, the computer 1102 including a processing unit 1106, a system memory 1104 and/or a system bus 1108. One or more aspects of the processing unit 1106 can be applied to processors associated with the devices of FIGS. 1, 2, 5 and/or 7.

Memory 1104 can store one or more computer and/or machine readable, writable and/or executable components and/or instructions that, when executed by processing unit 1106 (e.g., a classical processor, a quantum processor and/or like processor), can provide performance of operations defined by the executable component(s) and/or instruction(s). For example, memory 1104 can store computer and/or machine readable, writable and/or executable components and/or instructions that, when executed by processing unit 1106, can provide execution of the one or more functions described herein relating to the devices of FIGS. 1, 2, 5 and/or 7, as described herein with or without reference to the one or more figures of the one or more embodiments.

Memory 1104 can comprise volatile memory (e.g., random access memory (RAM), static RAM (SRAM), dynamic RAM (DRAM) and/or the like) and/or non-volatile memory (e.g., read only memory (ROM), programmable ROM (PROM), electrically programmable ROM (EPROM), electrically erasable programmable ROM (EEPROM) and/or the like) that can employ one or more memory architectures.

Processing unit 1106 can comprise one or more types of processors and/or electronic circuitry (e.g., a classical processor, a quantum processor and/or like processor) that can implement one or more computer and/or machine readable, writable and/or executable components and/or instructions that can be stored at memory 1104. For example, processing unit 1106 can perform one or more operations that can be specified by computer and/or machine readable, writable and/or executable components and/or instructions including, but not limited to, logic, control, input/output (I/O), arithmetic and/or the like. In one or more embodiments, processing unit 1106 can be any of one or more commercially available processors. In one or more embodiments, processing unit 1106 can comprise one or more central processing unit, multi-core processor, microprocessor, dual microprocessors, microcontroller, System on a Chip (SOC), array processor, vector processor, quantum processor and/or another type of processor. The examples of processing unit 1106 can be employed to implement one or more embodiments described herein.

The system bus 1108 can couple system components including, but not limited to, the system memory 1104 to the processing unit 1106. The system bus 1108 can comprise one or more types of bus structure that can further interconnect to a memory bus (with or without a memory controller), a peripheral bus and/or a local bus using one or more of a variety of commercially available bus architectures. The system memory 1104 can include ROM 1110 and/or RAM 1112. A basic input/output system (BIOS) can be stored in a non-volatile memory such as ROM, erasable programmable read only memory (EPROM) and/or EEPROM, which BIOS contains the basic routines that help to transfer information among elements within the computer 1102, such as during startup. The RAM 1112 can include a high-speed RAM, such as static RAM for caching data.

The computer 1102 can include an internal hard disk drive (HDD) 1114 (e.g., EIDE, SATA), one or more external storage devices 1116 (e.g., a magnetic floppy disk drive (FDD), a memory stick or flash drive reader, a memory card reader and/or the like) and/or a drive 1120, e.g., such as a solid state drive or an optical disk drive, which can read or write from a disk 1122, such as a CD-ROM disc, a DVD, a BD and/or the like. Additionally, and/or alternatively, where a solid state drive is involved, disk 1122 could not be included, unless separate. While the internal HDD 1114 is illustrated as located within the computer 1102, the internal HDD 1114 can also be configured for external use in a suitable chassis (not shown). Additionally, while not shown in operating environment 1100, a solid state drive (SSD) can be used in addition to, or in place of, an HDD 1114. The HDD 1114, external storage device(s) 1116 and drive 1120 can be connected to the system bus 1108 by an HDD interface 1124, an external storage interface 1126 and a drive interface 1128, respectively. The HDD interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, other types of storage media which are readable by a computer, whether presently existing or developed in the future, can also be used in the example operating environment, and/or that any such storage media can contain computer-executable instructions for performing the methods described herein.

A number of program modules can be stored in the drives and RAM 1112, including an operating system 1130, one or more applications 1132, other program modules 1134 and/or program data 1136. All or portions of the operating system, applications, modules and/or data can also be cached in the RAM 1112. The systems and/or methods described herein can be implemented utilizing one or more commercially available operating systems and/or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In a related embodiment, operating system 1130 can comprise one virtual machine (VM) of multiple VMs hosted at computer 1102. Furthermore, operating system 1130 can provide runtime environments, such as the JAVA runtime environment or the .NET framework, for applications 1132. Runtime environments are consistent execution environments that can allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and/or settings for an application.

Further, computer 1102 can be enabled with a security module, such as a trusted processing module (TPM). For instance, with a TPM, boot components hash next in time boot components and wait for a match of results to secured values before loading a next boot component. This process can take place at any layer in the code execution stack of computer 1102, e.g., applied at application execution level and/or at operating system (OS) kernel level, thereby enabling security at any level of code execution.

An entity can enter and/or transmit commands and/or information into the computer 1102 through one or more wired/wireless input devices, e.g., a keyboard 1138, a touch screen 1140 and/or a pointing device, such as a mouse 1142. Other input devices (not shown) can include a microphone, an infrared (IR) remote control, a radio frequency (RF) remote control and/or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint and/or iris scanner, and/or the like. These and other input devices can be connected to the processing unit 1106 through an input device interface 1144 that can be coupled to the system bus 1108, but can be connected by other interfaces, such as a parallel port, an IEEE 1394 serial port, a game port, a USB port, an IR interface, a BLUETOOTH® interface and/or the like.

A monitor 1146 or other type of display device can be alternatively and/or additionally connected to the system bus 1108 via an interface, such as a video adapter 1148. In addition to the monitor 1146, a computer typically includes other peripheral output devices (not shown), such as speakers, printers and/or the like.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device and/or other common network node, and typically includes many or all of the elements described relative to the computer 1102, although, for purposes of brevity, only a memory/storage device 1152 is illustrated. Additionally, and/or alternatively, the computer 1102 can be coupled (e.g., communicatively, electrically, operatively, optically and/or the like) to one or more external systems, sources and/or devices (e.g., classical and/or quantum computing devices, communication devices and/or like device) via a data cable (e.g., High-Definition Multimedia Interface (HDMI), recommended standard (RS) 232, Ethernet cable and/or the like).

In one or more embodiments, a network can comprise one or more wired and/or wireless networks, including, but not limited to, a cellular network, a wide area network (WAN) (e.g., the Internet), or a local area network (LAN). For example, one or more embodiments described herein can communicate with one or more external systems, sources and/or devices, for instance, computing devices (and vice versa) using virtually any specified wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an advanced and adaptive network technology (ANT), an ultra-wideband (UWB) standard protocol and/or other proprietary and/or non-proprietary communication protocols. In a related example, one or more embodiments described herein can include hardware (e.g., a central processing unit (CPU), a transceiver, a decoder, quantum hardware, a quantum processor and/or the like), software (e.g., a set of threads, a set of processes, software in execution, quantum pulse schedule, quantum circuit, quantum gates and/or the like) and/or a combination of hardware and/or software that supports communicating information among one or more embodiments described herein and external systems, sources and/or devices (e.g., computing devices, communication devices and/or the like).

The logical connections depicted include wired/wireless connectivity to a local area network (LAN) 1154 and/or larger networks, e.g., a wide area network (WAN) 1156. LAN and WAN networking environments can be commonplace in offices and companies and can facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired and/or wireless communication to the LAN 1154, which can also include a wireless access point (AP) disposed thereon for communicating with the adapter 1158 in a wireless mode.

When used in a WAN networking environment, the computer 1102 can include a modem 1160 and/or can be connected to a communications server on the WAN 1156 via other means for establishing communications over the WAN 1156, such as by way of the Internet. The modem 1160, which can be internal and/or external and a wired and/or wireless device, can be connected to the system bus 1108 via the input device interface 1144. In a networked environment, program modules depicted relative to the computer 1102 or portions thereof can be stored in the remote memory/storage device 1152. The network connections shown are merely exemplary and one or more other means of establishing a communications link among the computers can be used.

When used in either a LAN or WAN networking environment, the computer 1102 can access cloud storage systems or other network-based storage systems in addition to, and/or in place of, external storage devices 1116 as described above, such as but not limited to, a network virtual machine providing one or more aspects of storage and/or processing of information. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, such as with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices and/or entities operatively disposed in wireless communication, e.g., a printer, scanner, desktop and/or portable computer, portable data assistant, communications satellite, telephone and/or any piece of equipment or location associated with a wirelessly detectable tag (e.g., a kiosk, news stand, store shelf and/or the like). This can include Wireless Fidelity (Wi-Fi) and BLUETOOTH® wireless technologies. Thus, the communication can be a predefined structure as with a conventional network or simply an ad hoc communication between at least two devices.

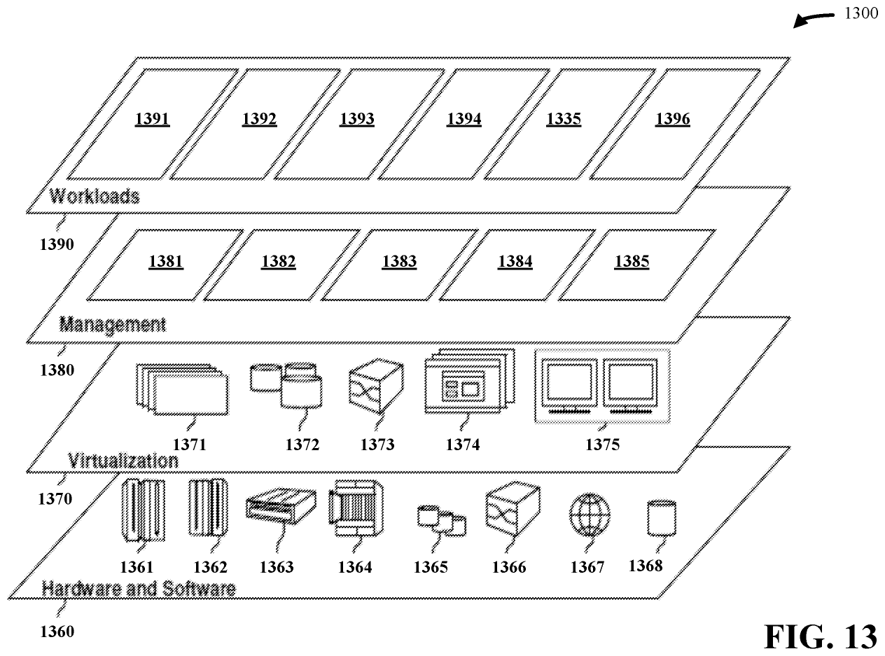

The illustrated embodiments described herein can be employed relative to distributed computing environments (e.g., cloud computing environments), such as described below with respect to FIG. 13, where certain tasks are performed by remote processing devices that are linked through a communications network. In a distributed computing environment, program modules can be located both in local and/or remote memory storage devices.

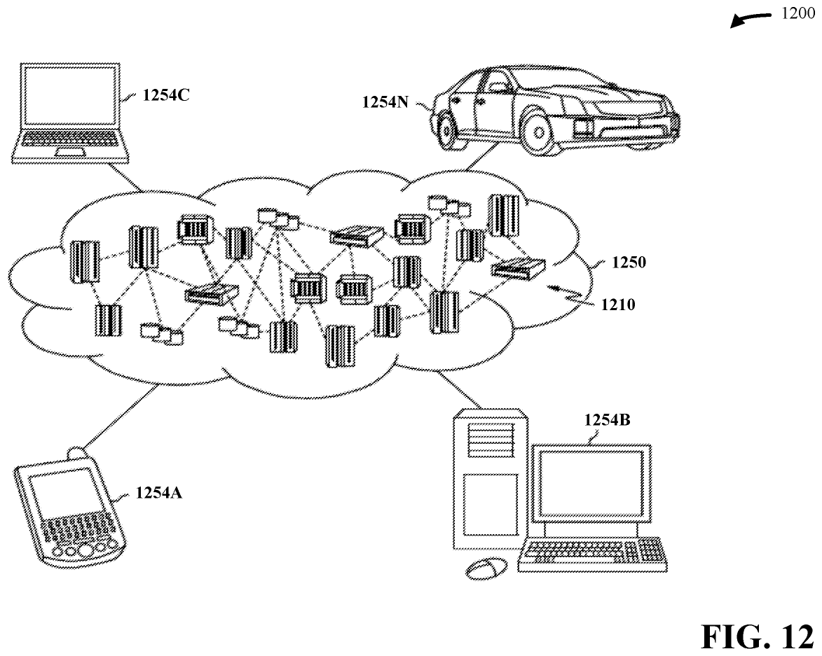

For example, one or more embodiments described herein and/or one or more components thereof can employ one or more computing resources of the cloud computing environment 1250 described below with reference to illustration 1200 of FIG. 12, and/or with reference to the one or more functional abstraction layers (e.g., quantum software and/or the like) described below with reference to FIG. 13, to execute one or more operations in accordance with one or more embodiments described herein. For example, cloud computing environment 1250 and/or one or more of the functional abstraction layers 1360, 1370, 1380 and/or 1390 can comprise one or more classical computing devices (e.g., classical computer, classical processor, virtual machine, server and/or the like), quantum hardware and/or quantum software (e.g., quantum computing device, quantum computer, quantum processor, quantum circuit simulation software, superconducting circuit and/or the like) that can be employed by one or more embodiments described herein and/or components thereof to execute one or more operations in accordance with one or more embodiments described herein. For instance, one or more embodiments described herein and/or components thereof can employ such one or more classical and/or quantum computing resources to execute one or more classical and/or quantum: mathematical function, calculation and/or equation; computing and/or processing script; algorithm; model (e.g., artificial intelligence (AI) model, machine learning (ML) model and/or like model); and/or other operation in accordance with one or more embodiments described herein.

It is to be understood that although one or more embodiments described herein include a detailed description on cloud computing, implementation of the teachings recited herein are not limited to a cloud computing environment. Rather, one or more embodiments described herein are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines and/or services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can specify location at a higher level of abstraction (e.g., country, state and/or datacenter).

Rapid elasticity: capabilities can be rapidly and elastically provisioned, in one or more cases automatically, to quickly scale out and rapidly released to quickly scale in. To the consumer, the capabilities available for provisioning can appear to be unlimited and can be purchased in any quantity at any time.

Measured service: cloud systems automatically control and optimize resource use by leveraging a metering capability at one or more levels of abstraction appropriate to the type of service (e.g., storage, processing, bandwidth and/or active user accounts). Resource usage can be monitored, controlled and/or reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage and/or individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems and/or storage, but has control over the deployed applications and possibly application hosting environment configurations.

Infrastructure as a Service (IaaS): the capability provided to the consumer is to provision processing, storage, networks and/or other fundamental computing resources where the consumer can deploy and run arbitrary software, which can include operating systems and applications. The consumer does not manage or control the underlying cloud infrastructure but has control over operating systems, storage, deployed applications and/or possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy and/or compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community or public) that remain unique entities but are bound together by standardized or proprietary technology that enables data and application portability (e.g., cloud bursting for load-balancing among clouds).

A cloud computing environment is service oriented with a focus on statelessness, low coupling, modularity and/or semantic interoperability. At the heart of cloud computing is an infrastructure that includes a network of interconnected nodes.

Moreover, the non-limiting system 100 and/or the example operating environment 800 can be associated with and/or be included in a data analytics system, a data processing system, a graph analytics system, a graph processing system, a big data system, a social network system, a speech recognition system, an image recognition system, a graphical modeling system, a bioinformatics system, a data compression system, an artificial intelligence system, an authentication system, a syntactic pattern recognition system, a medical system, a health monitoring system, a network system, a computer network system, a communication system, a router system, a server system, a high availability server system (e.g., a Telecom server system), a Web server system, a file server system, a data server system, a disk array system, a powered insertion board system, a cloud-based system and/or the like. In accordance therewith, non-limiting system 100 and/or example operating environment 800 can be employed to use hardware and/or software to solve problems that are highly technical in nature, that are not abstract and/or that cannot be performed as a set of mental acts by a human.

Referring now to details of one or more aspects illustrated at FIG. 12, the illustrative cloud computing environment 1250 is depicted. As shown, cloud computing environment 1250 includes one or more cloud computing nodes 1210 with which local computing devices used by cloud consumers, such as, for example, personal digital assistant (PDA) or cellular telephone 1254A, desktop computer 1254B, laptop computer 1254C and/or automobile computer system 1254N can communicate. Although not illustrated in FIG. 12, cloud computing nodes 1210 can further comprise a quantum platform (e.g., quantum computer, quantum hardware, quantum software and/or the like) with which local computing devices used by cloud consumers can communicate. Cloud computing nodes 1210 can communicate with one another. They can be grouped (not shown) physically or virtually, in one or more networks, such as Private, Community, Public, or Hybrid clouds as described hereinabove, or a combination thereof. This allows cloud computing environment 1250 to offer infrastructure, platforms and/or software as services for which a cloud consumer does not need to maintain resources on a local computing device. It is understood that the types of computing devices 1254A-N shown in FIG. 12 are intended to be illustrative only and that cloud computing nodes 1210 and cloud computing environment 1250 can communicate with any type of computerized device over any type of network and/or network addressable connection (e.g., using a web browser).

Referring now to details of one or more aspects illustrated at FIG. 13, a set 1300 of functional abstraction layers is shown, such as provided by cloud computing environment 1250 (FIG. 12). One or more embodiments described herein can be associated with, such as accessible via, one or more functional abstraction layers described below with reference to FIG. 13 (e.g., hardware and software layer 1360, virtualization layer 1370, management layer 1380 and/or workloads layer 1390). It should be understood in advance that the components, layers and/or functions shown in FIG. 13 are intended to be illustrative only and embodiments described herein are not limited thereto. As depicted, the following layers and/or corresponding functions are provided:

Hardware and software layer 1360 can include hardware and software components. Examples of hardware components include: mainframes 1361; RISC (Reduced Instruction Set Computer) architecture-based servers 1362; servers 1363; blade servers 1364; storage devices 1365; and/or networks and/or networking components 1366. In one or more embodiments, software components can include network application server software 1367, quantum platform routing software 1368; and/or quantum software (not illustrated in FIG. 13).

Virtualization layer 1370 can provide an abstraction layer from which the following examples of virtual entities can be provided: virtual servers 1371; virtual storage 1372; virtual networks 1373, including virtual private networks; virtual applications and/or operating systems 1374; and/or virtual clients 1375.

In one example, management layer 1380 can provide the functions described below. Resource provisioning 1381 can provide dynamic procurement of computing resources and other resources that can be utilized to perform tasks within the cloud computing environment. Metering and Pricing 1382 can provide cost tracking as resources are utilized within the cloud computing environment, and/or billing and/or invoicing for consumption of these resources. In one example, these resources can include one or more application software licenses. Security can provide identity verification for cloud consumers and/or tasks, as well as protection for data and/or other resources. User (or entity) portal 1383 can provide access to the cloud computing environment for consumers and system administrators. Service level management 1384 can provide cloud computing resource allocation and/or management such that required service levels are met. Service Level Agreement (SLA) planning and fulfillment 1385 can provide pre-arrangement for, and procurement of, cloud computing resources for which a future requirement is anticipated in accordance with an SLA.

Workloads layer 1390 can provide examples of functionality for which the cloud computing environment can be utilized. Non-limiting examples of workloads and functions which can be provided from this layer include: mapping and navigation 1391; software development and lifecycle management 1392; virtual classroom education delivery 1393; data analytics processing 1394; transaction processing 1395; and/or application transformation software 1396.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures and/or the like that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system. In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a first qubit chip and a second qubit chip;
a plurality of coupling elements electrically coupling together the first qubit chip and the second qubit chip; and
an interposer chip electrically coupling together the plurality of coupling elements.

2. The system of claim 1, wherein the coupling elements are resonators that are capacitively-coupled to one another.

3. The system of claim 2, wherein the resonators are coplanar waveguide resonators.

4. The system of claim 1, further comprising:
at least three series-connected coupling elements, wherein the middle coupling element is a fixed frequency coupling element.

5. The system of claim 1, further comprising:
at least three series-connected coupling elements, wherein the two outer coupling elements are tunable frequency coupling elements.

6. The system of claim 5, further comprising:
a superconducting quantum interference device disposed at the two outer coupling elements.

7. The system of claim 1, further comprising:
at least three series-connected coupling elements, wherein all three coupling elements are fixed frequency coupling elements.

8. The system of claim 1, further comprising:
a superconducting quantum interference device (SQUID) loop located between a structure on the first qubit chip and a structure on the second qubit chip.

9. The system of claim 1, wherein the coupling elements comprise a first coupling element physically coupled to the first qubit chip and to the interposer chip, a second coupling element physically coupled to the second qubit chip and to the interposer chip, and a third coupling separate from direct coupling to either of the first qubit chip or the second qubit chip.

10. The system of claim 1, further comprising:
a pulse generation component that generates a pulse to affect the first qubit or the second qubit.

11. A method, comprising:
electrically coupling together a first qubit chip and a second qubit chip by a plurality of coupling elements across an interposer chip.

12. The method of claim 11, further comprising:
coupling the coupling elements together in series.

13. The method of claim 11, further comprising:
coupling a capacitor between sets of two connected coupling elements.

14. The method of claim 11, further comprising:
coupling a superconducting quantum interference device at a coupling element of the plurality of coupling elements.

13. A method comprising:
executing a quantum operation at a quantum device comprising a pair of qubits electrically connected to one another across an interposer chip by a plurality of coupling elements.

16. The method of claim 15, wherein the plurality of coupling elements comprise series-connected, capacitively-coupled resonators.

17. The method of claim 16, further comprising:
executing the quantum operation by operating a cross-resonance gate.

18. The method of claim 16, further comprising:
flux tuning a resonator of the plurality of coupling elements.

19. The method of claim 16, further comprising:
tuning a qubit of the pair of qubits into a tunable-frequency coupling element of the plurality of coupling elements.

20. A system comprising:
a first chip comprising a plurality of first qubits;
a second chip comprising a plurality of second qubits; and
an interposer chip coupled to the first chip and to the second chip,
wherein at least one first qubit, of the plurality of first qubits, is electrically coupled to at least one second qubit, of the plurality of second qubits, and wherein the electrical coupling of the individual first qubits to the individual second qubits is by series-connected sets of capacitively-coupled elements over the interposer chip.

21. The system of claim 20, wherein the capacitively-coupled elements of the series-connected sets comprise at least three resonators, wherein the resonators are fixed frequency resonators.

22. The system of claim 21, where the frequency of the fixed frequency resonators are above the frequency of the at least one first qubit and the at least one second qubit.

23. The system of claim 20, wherein the capacitively-coupled elements of the series-connected sets comprise at least three resonators, wherein at least one resonator is a fixed frequency resonator, and wherein at least one resonator is a tunable frequency resonator.

24. The system of claim 23, wherein the frequency of the at least three resonators are above the frequency of the at least one first qubit and the at least one second qubit.

25. The system of claim 20, wherein the capacitively-coupled elements of the series-connected sets comprise at least three resonators, and wherein at least one resonator of the at least three resonators is located on the first chip and on the interposer chip.
